(19) United States
(12) Patent Application Publication
(10) Pub. No.: US 2012/0273730 A1
(43) Pub. Date: Nov. 1, 2012

(54) CONDUCTIVE POLYMER SOLUTION AND PREPARATION METHOD THEREOF

(75) Inventors: Chun-Guey Wu, Hualien City (TW); Chien-Hung Chiang, Tainan City (TW)

(73) Assignee: National Central University, Jhongli City (TW)

(21) Appl. No.: 13/211,277

(22) Filed: Aug. 16, 2011

(30) Foreign Application Priority Data
Apr. 26, 2011 (TW) 100114469

(51) Int. Cl. H01B 1/12

(52) U.S. Cl. 252/500

(57) ABSTRACT

A conductive polymer solution includes one doped conjugated polymer and one organic solvent. The doped conjugated polymer has electrical conductivity, and is selected from the group consisting of polyacetylenes, polypyrroles, polyparaphenylenes, polythiophenes, polyfurans, poly(3,4-ethylenedioxythiophenes), poly(3,4-propylenedioxythiophenes) (PProDOT), polythianaphthenes, polyanilines, and their copolymers, derivatives and combinations. The organic solvent is selected from the group consisting of a fluorinated organic solvent, mixture solvents containing fluorinated organic solvents, and mixture solvents containing fluorinated and non-fluorinated organic solvents. The organic solvent is mixed with the doped conjugated polymer. A preparation method of the conductive polymer solution is also disclosed.

### CROSS REFERENCE TO RELATED APPLICATIONS

This Non-provisional application claims priority under 35 U.S.C. §119(a) on Patent Application No(s). 100114469 filed in Taiwan, Republic of China on Apr. 26, 2011, the entire contents of which are hereby incorporated by reference.

### BACKGROUND OF THE INVENTION

1. Field of Invention

The present invention relates to a polymer solution and preparation method thereof, and more particular, to a conductive polymer solution and preparation method thereof.

2. Related Art

The conjugated polymer has the typical properties of both polymer and semiconductor/conductor. The electrical conductivity of the conjugated polymer can be changed reversibly by oxidation/reduction or adding acid/base. Conjugated polymer was made as a film form when it was applied to solar cell, capacitor, light-emitting diode (LED), chemical sensor, pattern etching, anti-corrosion, electrode material, EMI shielding, electrochromic, and electrostatic discharge (ESD) protection. The known conjugated polymers include polyacetylenes, polypyrroles, polyparaphenylenes, polythiophenes, polyfurans, polythianaphthenes, polyanilines (PANI), and their derivatives or copolymers. In order to prepare the conductive polymer film, the conventional art usually dissolves the conjugated polymer in the solvent such as water or organic liquid to form a proper polymer solution for the following operation. Herein, the concentration of the polymer solution can not only affect the electrical conductivity, but also the quality of the resulting conductive polymer film which is formed by dip coating or spin coating from the polymer solution.

The conventional method for the preparation of the conductive polymer solution is to mix the non-doped conjugated polymer powder and the solvent. After the polymer film is made, the dopant is then added to dope the polymer film. Alternatively, it is also possible to mix the non-doped conjugated polymer powder and the solvent as well as the dopant, thereby forming the doped conjugated polymer solution. Conductive polymer film made from the doped conductive polymer solution therefore has higher conductivity. However, if the boiling point of the solvent is too high, or various amounts or types of dopants need to be added with respect to different conjugated polymers to achieve better electrical conductivity. This preparation method makes the processes for preparing conductive thin film very complicated and the organic solvent may remain, which will affect the properties of the polymer film. In addition, the doped conductive polymer solution cannot be made reversibly sometimes due to the complicated preparation procedure.

Therefore, it is desired to simplify the preparation steps for making conductive polymer film and to provide a proper solvent that has lower boiling point and good solubility for the doped conjugated polymer, thereby increasing the electrical conductivity of the conductive polymer film fabricated from the solution. Furthermore, it is also important to make a conducting polymer solution suitable for solution coating process in a relatively simple way.

### SUMMARY OF THE INVENTION

In view of the foregoing, an object of the present invention is to provide a high concentration conductive polymer solution and the preparation method thereof.

To achieve the above object, the present invention discloses a conductive polymer solution including a doped conjugated polymer and an organic solvent. The organic solvent is mixed with the doped conjugated polymer. The doped conjugated polymer has electrical conductivity, and is selected from the group consisting of polyacetylenes, polypyrroles, polyparaphenylenes, polythiophenes, polyfurans, poly(3,4-ethylenedioxythiophenes), poly(3,4-propylenedioxythiophenes) (PProDOT), polythianaphthenes, polyanilines, and their copolymers, derivatives and combinations.

In one embodiment, the structural formula of the doped conjugated polymer is selected from one of the following formula (1) to formula (11), and their derivations, copolymers and combinations, and the structural formula of the organic solvent is selected from one of the following formulas (12) and (13), and their combinations.

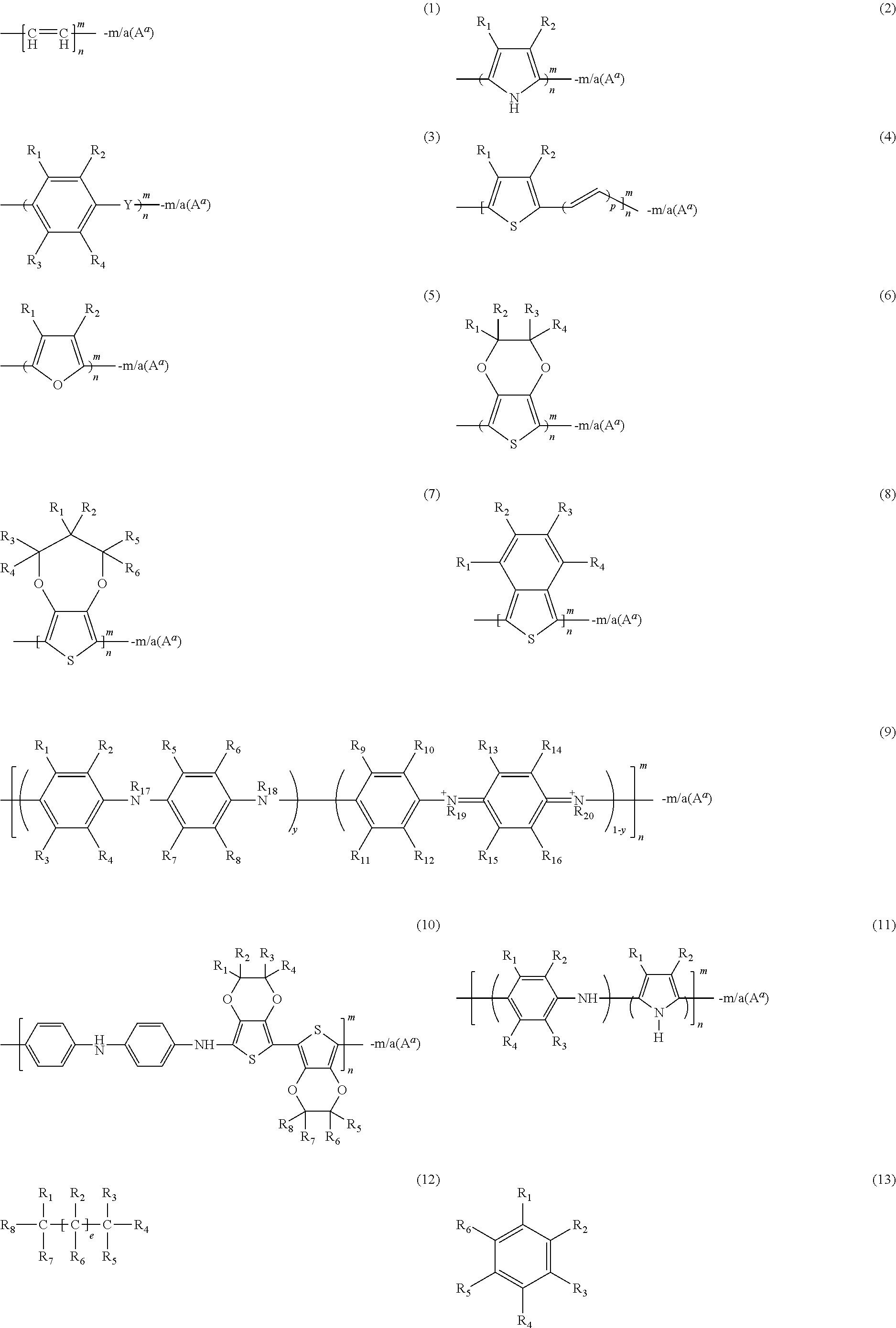

In one embodiment, n of the formulas (1) to (11) is an integer between 3 and 5000, each of R₁ to R₂₀ of the formulas (2) to (11) is one selected from H, F, Cl, Br, I, amino, formyl, carboxyl, OCⱼH₂ⱼ₋₁, CⱼH₂ⱼ₊₁, SCⱼH₂ⱼ₊₁, N(CⱼH₂ⱼ₊₁)₂, CⱼH₂ⱼ₊₁SO₃H, and CⱼH₂ⱼPO₃H₂, j is an integer between 0 and 8, Y of the formula (3) is one selected from S, O, C₆H₄, C═C, C═N, and N═N, p of the formula (4) is an integer between 0 and 3, y of the formula (9) is between 0 and 1, m of the formulas (1) to (11) is an integer between −5000 and 5000, a of the formula (1) to the formula (11) is an integer between −5000 and 5000, and A^{a} of the formulas (1) to (11) is an organic anion or cation (e.g. camphorsulfonic acid (CSA⁻¹), methylsulfonic acid (MSA⁻¹), toluene-p-sulfonic acid (TsO⁻¹), dodecylbenzenesulfonic acid (DBSA⁻¹), N-alkylpyridinium ([CnPY]⁺), or one of following formulas (14) to (16)), or an inorganic anion or cation (e.g. F⁻¹, Br⁻¹, Cl⁻¹, SO₄⁻², PO₄⁻³, ClO₄⁻¹, ClO₂⁻¹, BF₄⁻¹, NO₃⁻¹, NH₄⁺, Na⁺, K⁺).

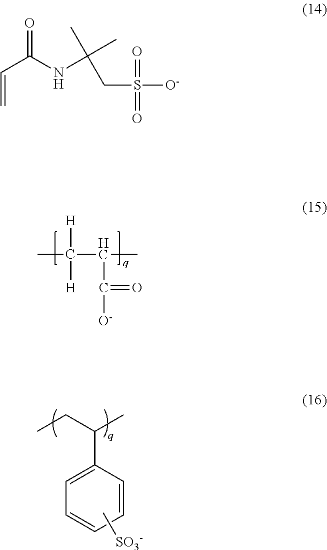

In one embodiment, e of the formula (12) is an integer between 0 and 5, and each of R₁ to R₈ of the formulas (12) and (13) is one selected from H, F, Cl, Br, I, amino, formyl, carboxyl, OCⱼH₂ⱼ₋₁, CⱼH₂ⱼ₊₁, SCⱼH₂ⱼ₊₁, N(CⱼH₂ⱼ₊₁)₂, CⱼH₂ⱼ₊₁SO₃H, and CⱼH₂ⱼPO₃H₂, wherein j is an integer between 0 and 8.

In one embodiment, q of the formulas (15) and (16) is an integer between 1 and 5000.

In one embodiment, the doped conjugated polymer is an acid doped conjugated polymer or an oxidant doped conjugated polymer.

In one embodiment, the organic solvent is selected from a fluorinated organic solvent, mixture solvents containing fluorinated organic solvents, and mixture solvents containing fluorinated and none-fluorinated organic solvents.

In one embodiment, the organic solvent is selected from hexafluoroisopropanol (HFIP), 1,1,1,3,3,3 -hexafluoro-2-phenyl-2-propanol (HFPP), 1,1,1,3,3,3 -hexafluoro-2-(mtolyl)-propanol (HFTP), perfluoropropane (PFP), and their combinations.

In one embodiment, the concentration of the doped conjugated polymer is less than 40 weight %.

In one embodiment, the conductive polymer solution is applied to solar cell, capacitor, light-emitting diode (LED), chemical sensor, pattern etching, anti-corrosion, electrostatic discharge (ESD) protection, electrode material, EMI shielding, and electrochromic display.

In addition, the present invention also discloses a preparation method of a conductive polymer solution, including the following steps: mixing a monomer of a conjugated polymer and an oxidant in an acid solution; conducting a polymerization; filtering the solution to obtain the solid residual; washing and doping the solid residual to obtain a doped conjugated polymer, wherein the doped conjugated polymer has electrical conductivity and is selected from the group consisting of polyacetylenes, polypyrroles, polyparaphenylenes, polythiophenes, polyfurans, poly(3,4-ethylenedioxythiophenes), poly(3,4-propylenedioxythiophenes), polythianaphthenes, polyanilines, and their copolymers, derivatives and combinations; and mixing the doped conjugated polymer with an organic solvent, wherein the structural formula of the organic solvent is selected from one of the formulas (12) and (13), and their combinations.

As mentioned above, the present invention is to dissolve the doped conjugated polymer, such as polyacetylenes, polypyrroles, polyparaphenylenes, polythiophenes, polyfurans, poly(3,4-ethylenedioxythiophenes), poly(3,4-propylenedioxythiophenes), polythianaphthenes, polyanilines, and their copolymers, derivatives and combinations, in the organic solvent which has low boiling point. The organic solvent with low boiling point is preferably a fluorinated organic solvent, mixture solvents containing fluorinated organic solvents, or mixture solvents containing fluorinated and none-fluorinated organic solvents. More preferably, the organic solvent such as HFIP, HFPP, HFTP, or PFP can provide superior solubility for the doped conjugated polymer. Thus, the concentration of the doped conjugated polymer can be increased so as to increase the electrical conductivity of the polymer film fabricated from the doped conjugated polymer solution. In addition, since the organic solvent has low boiling point, the residual organic solvent in the fabricated conductive polymer film can be sufficiently decreased. In practice, the films fabricated from the conductive polymer solution of this invention by coating or dip coating can be applied to dye-sensitized solar cell, electrolytic capacitor, light-emitting diode (LED), chemical sensor, pattern etching, anti-corrosion, electrostatic discharge (ESD) protection, electrode material, EMI shielding, and electrochromic display.

### BRIEF DESCRIPTION OF THE DRAWINGS

The invention will become more fully understood from the detailed description and accompanying drawings, which are given for illustration only, and thus are not limitative of the present invention, and wherein:

FIG. 1 depicts a ultraviolet/visible absorption spectra for a conductive polymer film of the invention reacted with vitamin C aqueous solution in different concentrations, wherein the conductive polymer film is a conductive polyaniline film applied to a chemical sensor;

FIG. 2 shows pictures of clips, wherein one of the clips is coated with the conductive polymer film fabricated from the polymer solution of the invention for avoiding corrosion; and

FIG. 3 is a graph showing the transmittance curve of the conductive polymer film fabricated from the polymer solution of the invention applied to electrochromic display, wherein the conductive polymer film is a conductive PEDOT film.

### DETAILED DESCRIPTION OF THE INVENTION

The present invention will be apparent from the following detailed description, which proceeds with reference to the accompanying drawings, wherein the same references relate to the same elements.

In the following embodiments of the invention, the conductive polymer solution includes a doped conjugated polymer and an organic solvent.

The conjugated polymer contains alternate single bond and double bond, thereby forming the conjugate bonds. The conjugated polymer inherently has electrical conductivity, so it is also called an intrinsic conductive polymer (ICP). In this embodiment, the monomer of the conjugated polymer can be any one selected from the group consisting of acetylenes, pyrroles, paraphenylenes, thiophenes, furans, 3,4-ethylenedioxythiophenes (EDOT), thianaphthenes, 3,4-propylenedioxythiophenes (ProDOT), anilines, and their copolymers, derivatives and combinations. For example, the following formulas (1) to (9) show the structural formulas of the homopolymers for the doped conjugated polymer, and the formulas (10) and (11) show the structural formulas of the copolymers composed two types of the above-mentioned monomers. In more detailed, the formula (10) is poly(aniline-co-3,4-ethylenedioxy-thiophene), which is a copolymer composed of aniline and EDOT. The formula (11) is poly(aniline-co-pyrrole), which is a copolymer composed of aniline and pyrrole.

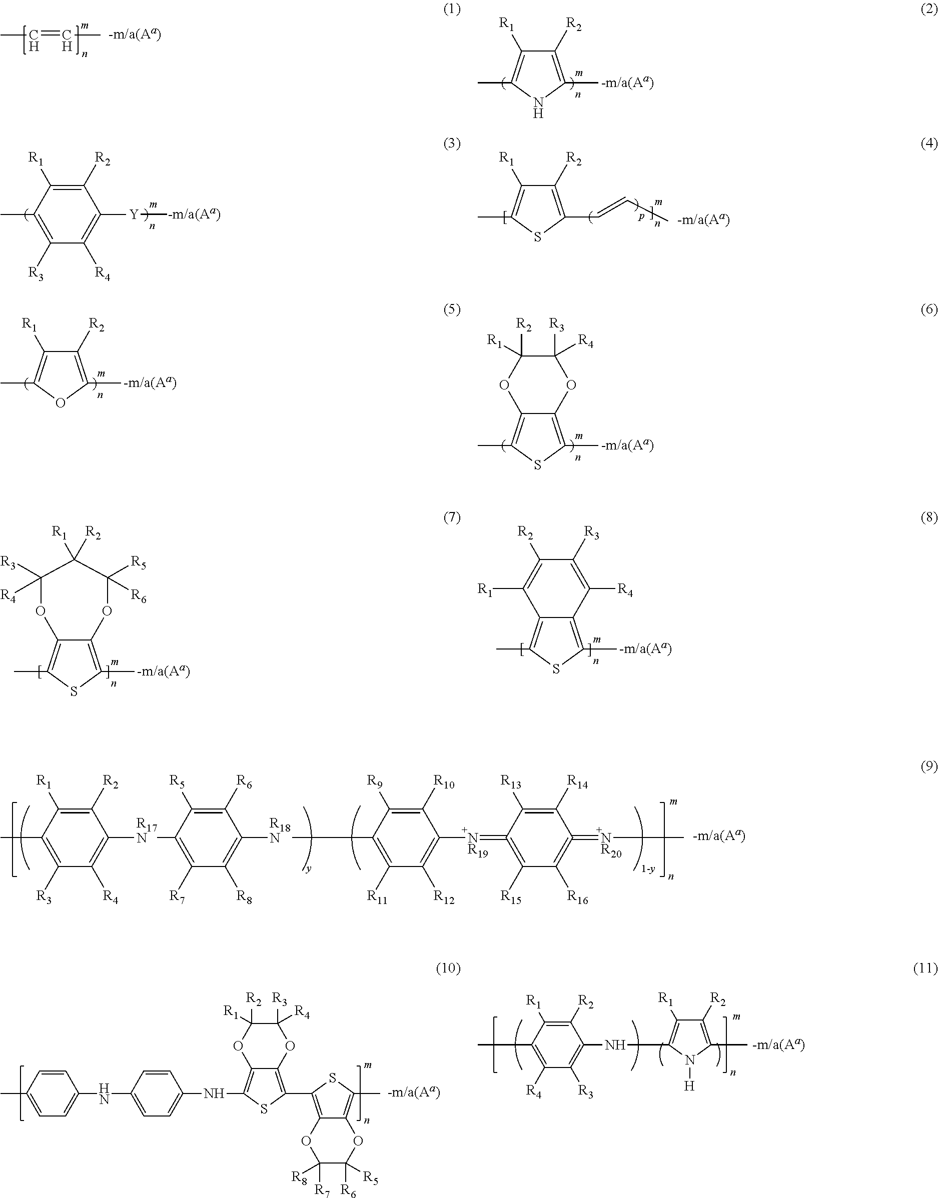

Wherein, formula (1) represents doped polyacetylenes, formula (2) represents doped polypyrroles and its derivations, formula (3) represents doped polyparaphenylenes and its derivations, formula (4) represents doped polythiophenes and its derivations, formula (5) represents doped polyfurans and its derivations, formula (6) represents doped poly(3,4-ethylenedioxythiophenes) and its derivations, formula (7) represents doped poly(3,4-propylenedioxythiophenes) and its derivations, formula (8) represents doped polythianaphthenes and its derivations, formula (9) represents doped polyanilines and its derivations.

Wherein, n of the formulas (1) to (11) is an integer between 3 and 5000, each of R₁ to R₂₀ of the formulas (2) to (11) is one selected from H, F, Cl, Br, I, amino, formyl, carboxyl, OCⱼH₂ⱼ₊₁, CⱼH₂ⱼ₊₁, SCⱼH₂ⱼ₊₁, N(CⱼH₂ⱼ₊₁)₂, CⱼH₂ⱼ₊₁SO₃H, and CⱼH₂ⱼPO₃H₂, j is an integer between 0 and 8, Y of the formula (3) is one selected from S, O, C₆H₄, C═C, C═N, and N═N, p of the formula (4) is an integer between 0 and 3, y of the formula (9) is between 0 and 1, m of the formulas (1) to (11) is an integer between −5000 and 5000, a of the formula (1) to the formula (11) is an integer between −5000 and 5000, and A^{a} of the formulas (1) to (11) is an organic anion or cation (e.g. camphorsulfonic acid (CSA⁻¹), methylsulfonic acid (MSA⁻¹), toluene-p-sulfonic acid (TsO⁻¹), dodecylbenzenesulfonic acid (DBSA⁻¹), N-alkylpyridinium ([CnPY]⁺), or one of following formulas (14) to (16)), or an inorganic anion or cation (e.g. F⁻¹, Br⁻¹, Cl⁻¹, I⁻¹, SO₄⁻², PO₄⁻¹, ClO₄⁻¹, ClO₂⁻¹, BF₄⁻¹, NO₃⁻¹, NH₄⁺, Na⁺, K⁺).

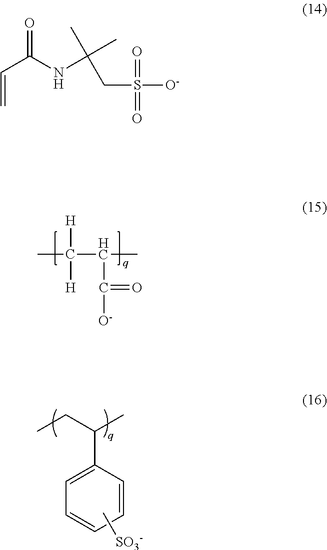

In order to increase the electrical conductivity of the conjugated polymer, this embodiment utilizes “doping” to produce the electrons or holes carriers to make the doped conjugated polymer with high electrical conductivity. In this embodiment, both acid doping and oxidant doping methods were used to increase the electrical conductivity of the conjugated polymer. For example, HCl aqueous solution was used for acid doping, and the oxidant doping can be performed with an ammonium peroxosulfate or ferric chloride.

The organic solvent is mixed with any of the above-mentioned doped conjugated polymer. The structural formula of the organic solvent is selected from one of the following formulas (12) and (13), and their combinations.

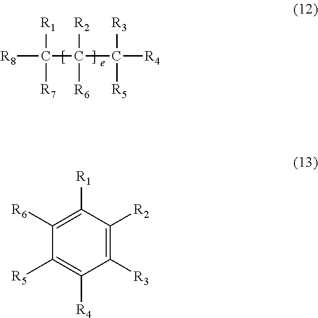

Wherein, e of the formula (12) is an integer between 0 and 5, and each of R₁ to R₈ of the formulas (12) and (13) is one selected from H, F, Cl, Br, I, amino, formyl, carboxyl, OCⱼH₂ⱼ₊₁, CⱼH₂ⱼ₊₁, SCⱼH₂ⱼ₊₁, N(CⱼH₂ⱼ₊₁)₂, CⱼJ₂ⱼ₋₁SO₃H, and CⱼH₂ⱼPO₃H₂, wherein j is an integer between 0 and 8.

Some examples for illustrating the conductive polymer solution and preparation method thereof of the invention will be described hereinafter, wherein the examples include the preparation of doped polyaniline, doped PEDOT, and doped polypyrrole as well as their mixture with organic solvents.

Synthesis and Doping of the Doped Polyaniline:

Ammonia persulfate ((NH₄)₂S₂O₈, 0.41 g) was dissolved in 10 ml 1.2 M HCl aqueous solution. Aniline monomer (0.17 g) was dissolved in 0.17 g, 0.01% phenol aqueous solution, followed by adding 26 ml 1.2 M HCl aqueous solution. The ammonium peroxosulfate/HCl aqueous solution and the aniline/HCl aqueous solution were mixed, and the polymerization reaction of the mixture was carried out at room temperature for 20 minutes. Dark green doped polyaniline (solid) was generated in the mixture. After the polymerization, the mixture was filtered, and the solid was washed by distilled water, methanol and HCl aqueous solution until the filtrate became colorless. The collected polyaniline powder was purified by Soxhlet extraction apparatus using acetone, acetonitrile and finally HCl aqueous solution, sequentially to wash the solid to obtain the desired doped polyaniline powder, which was dried and collected.

Synthesis and Doping of Doped poly(3,4-ethylenedioxythiophenes (PEDOT):

Ammonium peroxosulfate (0.41 g) was dissolved in 10 ml 1.2 M HCl aqueous solution. 3,4-ethylenedioxythiophene monomer (0.26 g) was dissolved in 26 ml 1.2 M HCl aqueous solution. The ammonium peroxosulfate/HCl aqueous solution and the 3,4-ethylenedioxythiophene/HCl aqueous solution were mixed at room temperature, and the polymerization reaction of the mixture was carried out for 24 hours. Blue doped PEDOT (solid) was generated in the mixture. The mixture was filtered, and the solid was washed with distilled water, methanol and HCl aqueous solution until the filtrate became colorless. The collected PEDOT powder was purified by soxhlet extraction apparatus, washed with acetone, acetonitrile and finally HCl aqueous solution, sequentially and then dried to obtain the desired powder product.

Synthesis and Doping of Doped Polypyrrole:

Ammonium peroxosulfate (0.41 g) was dissolved in 10 ml 1.2 M HCl aqueous solution. Pyrrole monomer (0.13 g) was dissolved in 26 ml 1.2 M HCl aqueous solution. The ammonium peroxosulfate/HCl aqueous solution and the pyrrole/HCl aqueous solution were mixed at room temperature, and the polymerization reaction of the mixture was carried out for 24 hours. Black doped polypyrrole (solid) was generated in the mixture. The mixture was filtered, and the solid was washed by distilled water, methanol and HCl aqueous solution until the filtrate became colorless. The collected polypyrrole powder was purified by soxhlet extraction apparatus, washed with acetone, acetonitrile and finally HCl aqueous solution, sequentially and then dried to obtain the desired powder product.

Mixing Doped Conjugated Polymer with Organic Solvent:

Doped polyaniline powder, doped PEDOT powder, and doped polypyrrole powder were separately dissolved in organic solvent (hexafluoroisopropanol, HFIP), and the mixtures was sonicated for several hours to obtain green polyaniline solution, blue PEDOT solution, and black polypyrrole solution. The concentrations of the doped conjugated polymers in the solutions can be up to 35, 40 and 15 weight % for polyaniline, PEDOT, and polypyrrole, respectively. Except HFIP, the usable organic solvent includes 1,1,1,3,3,3-hexa-fluoro-2-phenyl-2-propanol (HFPP), 1,1,1,3,3,3-hexafluoro-2-(ptolyl)-propanol (HFTP), or perfluoropropane (PFP). These organic solvent all have superior solubility for the doped conjugated polymer.

The following examples indicate that the doped conjugated polymers of the invention have good dispersion in the conductive polymer solution, and they can be applied to various electronic devices.

### EXAMPLE 1

### Conductive Polymer Solution Applied to Electrolytic Capacitor:

A porous aluminum oxide film was formed by applying 40 V voltage to an aluminum sheet to oxidize Al sheet for 30 minutes. After the conversion process, the sheet was washed by distilled water and dried by oven. The conductive polyaniline solution (prepared by dissolving conductive polyaniline of formula (17) in HFIP) was dropped on the etched porous aluminum oxide foil. After the solution was dried, a layer of carbon paste was applied and dried by oven to remove solvent. A silver paste was uniformly applied on the surface of the carbon paste, and it was also dried by oven to remove solvent. A gold foil was provided to cover the silver paste. The gold foil was connected to the negative electrode, and a wire was connected to the positive electrode. The capacitance thereof was measured and the results were shown in the following Table 1. The data indicates that the conductive polymer film made from the conductive polymer solution of the invention can be applied to fabricate capacitors.

TABLE 1
(17)

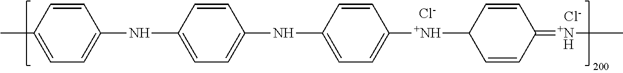

| Capacitance (120 Hz) | DF (120 Hz) | ESR (100 kHz) |
|---|---|---|
| 12.7 μF | 3.45% | 440 mΩ |

### EXAMPLE 2

### Conductive Polymer Solution Applied to LED:

The conductive polyaniline solution as used in Example 1 was dropped on a cleaned ITO glass substrate, and dried to form a film. MEH-PPV (poly[(2-((2-ethyl-hexyl)-oxy)-5-methoxy-p-phenylene)vinylene]), which was prepared by dissolving 6 mg MEH-PPV in 1 ml toluene, was applied thereon by spin coating. An aluminum film (2500 Å), which is used as the cathode, was deposited on the MEH-PPV film by vacuum evaporation, thereby fabricating a dual-layer organic LED using the conductive polyaniline film as the hole transport layer. Another single-layer organic LED without the conductive polyaniline film was fabricated by the same method. Comparing these two organic LED by respectively measuring their current-voltage curve and voltage-brightness curve (using a HP 4145 and PMT (Photomultiplier Tube)) as well as their turn-on voltage, luminance efficiency and barrier height. The results shown in Table 2 indicate that the performance of the OLED containing the polyaniline (PANI) film is better than that of the other OLED without the polyaniline film.

TABLE 2

| | | ITO/PANI/ |
|---|---|---|
| Structure | ITO/MEH-PPV/Al | MEH-PPV/Al |
| Electrode Area (mm²) | 1.13 | 1.13 |
| ^{a}Turn-on Voltage | 5.3 | 4.6 |
| Current Density | 30 | 54 |
| (mA/mm²) at 9 V | | |
| Brightness | 3513 | 9499 |
| (cd/m²) at 9 V | | |
| Luminance Efficiency | 0.12 | 0.18 |
| (cd/A) at 9 V | | |
| Barrier Height (eV) | 0.082 | 0.042 |

^{a}“Turn-on Voltage” is the applied voltage which makes the brightness of the device equal to 100 cd/m².

### EXAMPLE 3

### Conductive Polymer Solution Applied to the Chemical Sensor:

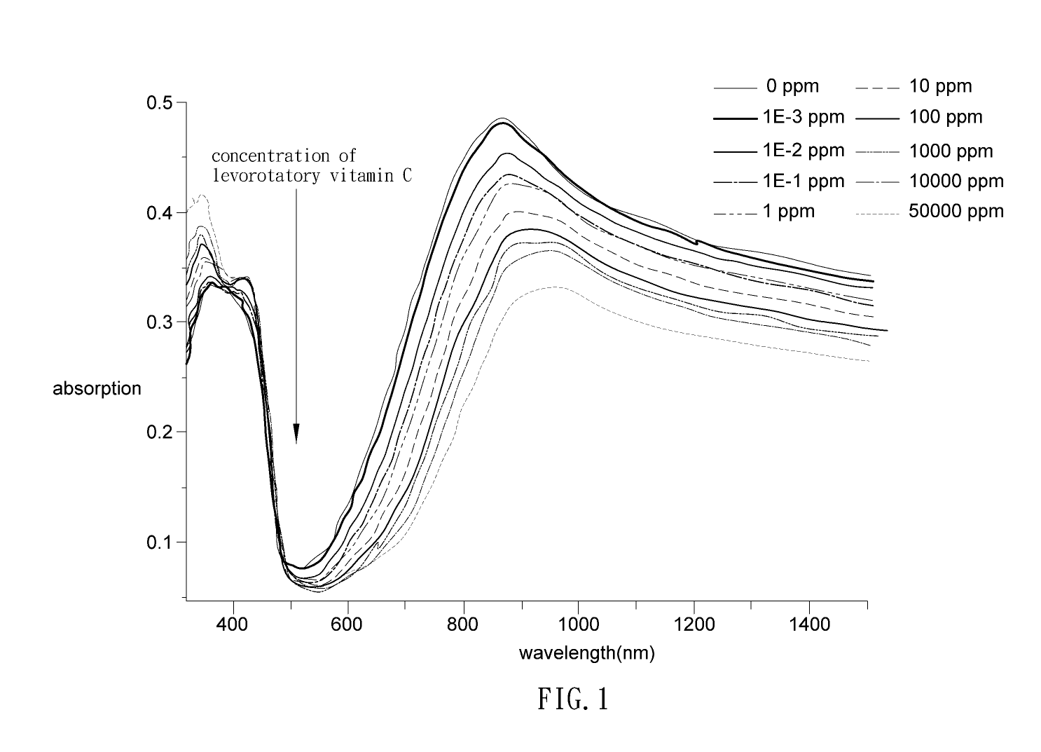

The conductive polyaniline solution was separately dropped on 10 cleaned PET (polyethylene terephthalate) plates, and then dried to form 10 conductive polyaniline films with similar thickness. 10 cups of levorotatory vitamin C aqueous solutions with the concentrations of 0 ppm, 10⁻³ ppm, 10⁻² ppm, 10⁻¹ ppm, 1 ppm, 10 ppm, 100 ppm, 1000 ppm, 10⁴ ppm, 5×10⁴ ppm, respectively were prepared, and the pH of all solutions were adjusted to 1 by HCl aqueous solution. The conductive polyaniline films were respectively placed in the levorotatory vitamin C aqueous solutions of different concentrations for 3 minutes, followed by measure the UV/visible absorption spectra of the conductive polyaniline films and the results were displayed in FIG. 1. When conductive polyaniline film is used as the chemical sensor, it can be placed in the levorotatory vitamin C aqueous solution, and then the concentrations of the levorotatory vitamin C aqueous solutions can be estimated by measuring the change of the absorption spectra before and after dipping in the vitamin C aqueous solution. The lowest detecting limit for vitamin C can be up to 10⁻³ ppm.

### EXAMPLE 4

### Conductive Polymer Solution Applied to Anti-Corrosion:

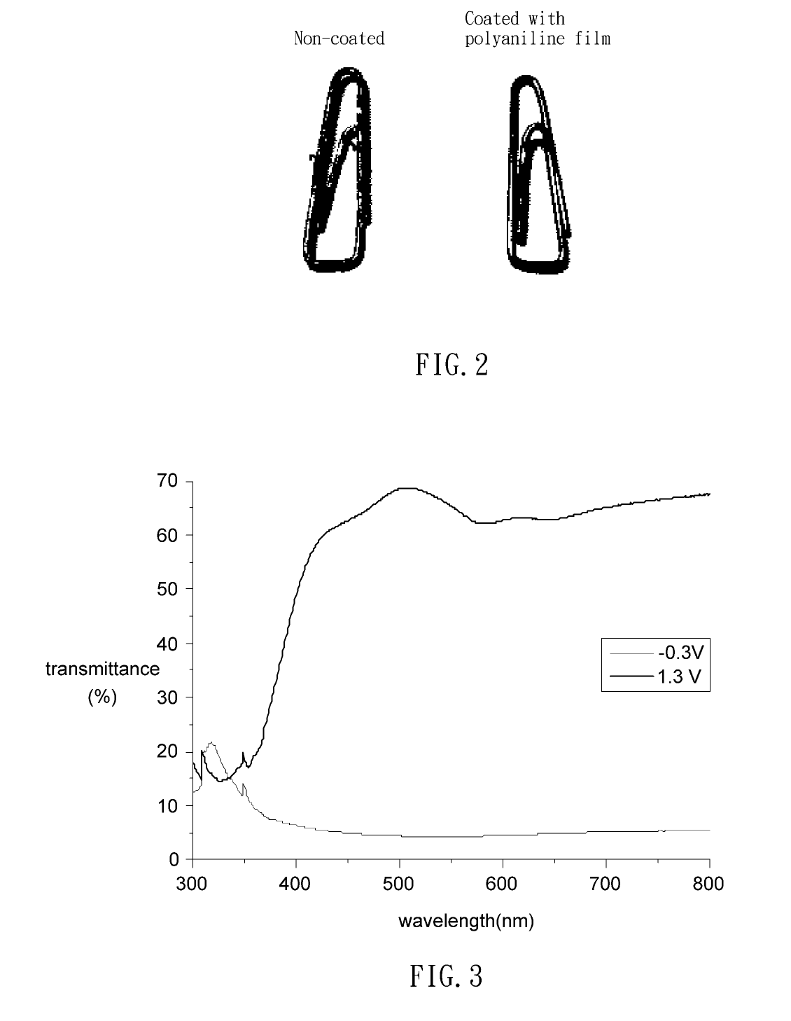

Taking two clips, one clip was coated with a layer of conductive polyaniline film by dip coating and the other did not. Then, these two clips were placed in 0.1 M HCl aqueous solution for 48 hours. The pictures shown in FIG. 2 reveals that the clip coated with the conductive polyaniline film is intact but the other clip without coating has been corroded seriously.

### EXAMPLE 5

### Conductive Polymer Solution Applied to Dye-Sensitized Solar Cell:

Titanium dioxide (TiO₂) paste was coated on a cleaned conductive FTO glass by screen printing. The TiO₂ coated conductive glass was then transferred into a tube furnace for calcining at 450° C. to convert TiO₂ into Anatase phase at the same time attached tightly to the FTO (fluorine-doped tin oxide) glass. TiO₂ electrode was formed by coating two layers of TiO₂ films and one TiO₂ scattering layer in order and then immersed in 3×10⁻⁴M N719 (cis-bis(isothiocyanato)bis-(2,2′-bipyridyl-4,4′-dicarboxylato)-ruthenium(II)bis-tetra-butylammonium) dye solution for 4 hours. Taking the TiO₂ electrode out and washed with alcohol, and then placed in a pitch dish for drying. In addition, different conductive polymer solutions including a conductive polyaniline (PANI) solution, a conductive PEDOT solution (prepared by adding doped PEDOT of formula (18) in HFIP), and a conductive polypyrrole solution (prepared by adding doped polypyrroles (PPy) of formula (19) in HFIP) were separately dropped on three FTO glasses, respectively, and then dried to obtain the conductive polymer counter electrodes. Surlyn® was used as sealer to sandwichedly assemble the dye-coated TiO₂ electrode and the conductive polymer coated counter electrode. Finally, the electrolyte prepared by dissolving 0.6 M BMII (N-methyl-N-butyl-imidazolium iodide), 0.1 M LiI, 0.05 M I₂, 0.5 M TBP (4-tert-butylpyridine), and 0.1 M GuNCS (guanidinium thiocyanate) in acetonitrile was injected through a hole on the counter electrode, followed by rapidly sealing the hole by a cover glass. The assembled dye-sensitized solar cell was irradiated by AM1.5 solar simulated light of 100 mW/cm², and the current-voltage curve was measured to calculate the photo-to-electron conversion efficiency. Similarly, a Pt film was used to substitute the conductive polymer film, and the current-voltage curve was measured under the same conditions. The results are shown in Table 3.

(18)

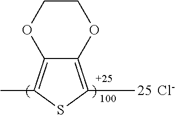

(19)

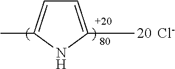

| | Current Density | Voltage | | Conversion |
|---|---|---|---|---|
| Electrode | (mA/cm²) | (V) | Fill Factor | Efficiency |
| Pt | 13.94 | 0.79 | 0.66 | 7.27 |
| PANI | 16.54 | 0.738 | 0.61 | 7.49 |
| PEDOT | 15.24 | 0.718 | 0.68 | 7.41 |
| PPy | 8.22 | 0.740 | 0.16 | 0.97 |

### EXAMPLE 6

### Conductive Polymer Solution Applied to Electrochromic Display:

The conductive PEDOT solution was applied on a conductive ITO glass by spin coating to form a PEDOT film. The electrochromic properties of the PEDOT film were measured. FIG. 3 shows the transmittance curves of the PEDOT film under different voltages. As shown in FIG. 3, one can observed that PEDOT film has excellent electrochromic contrast at full visible region.

In summary, the present invention is to find a solvent system to dissolve the doped conjugated polymer, such as polyacetylenes, polypyrroles, polyparaphenylenes, polythiophenes, polyfurans, poly(3,4-ethylenedioxythiophenes), poly(3,4-propylenedioxythiophenes), polythianaphthenes, polyanilines, and their copolymers, derivatives and combinations in high concentration. The organic solvent is preferably fluorinated organic solvent, mixture solvents containing fluorinated organic solvents, or mixture solvents containing fluorinated and non-fluorinated organic solvents. More preferably, the organic solvent such as HFIP, HFPP, or HFTP has a superior solubility for the doped conjugated polymers. Thus, the concentration of the doped conjugated polymer can be increased so as to increase the electrical conductivity of the film fabricated from the doped conjugated polymer solution. As proved by the above examples, doped polymer film made by coating or dip coating from the conductive polymer solution of the invention can be efficiently applied to dye-sensitized solar cell, electrolytic capacitor, light-emitting diode (LED), chemical sensor, pattern etching, anti-corrosion, electrostatic discharge (ESD) protection, electrode material, EMI shielding, and electrochromic display.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A conductive polymer solution comprising:
a doped conjugated polymer, which has electrical conductivity, and is selected from the group consisting of polyacetylenes, polypyrroles, polyparaphenylenes, polythiophenes, polyfurans, poly(3,4-ethylenedioxythiophenes), poly(3,4-propylenedioxythiophenes), polythianaphthenes, polyanilines, and their copolymers, derivatives and combinations; and
an organic solvent, which is mixed with the doped conjugated polymer.

2. The conductive polymer solution of claim 1, wherein the structural formula of the doped conjugated polymer is selected from one of the following formula (1) to formula (11), and their derivations, copolymers and combinations:

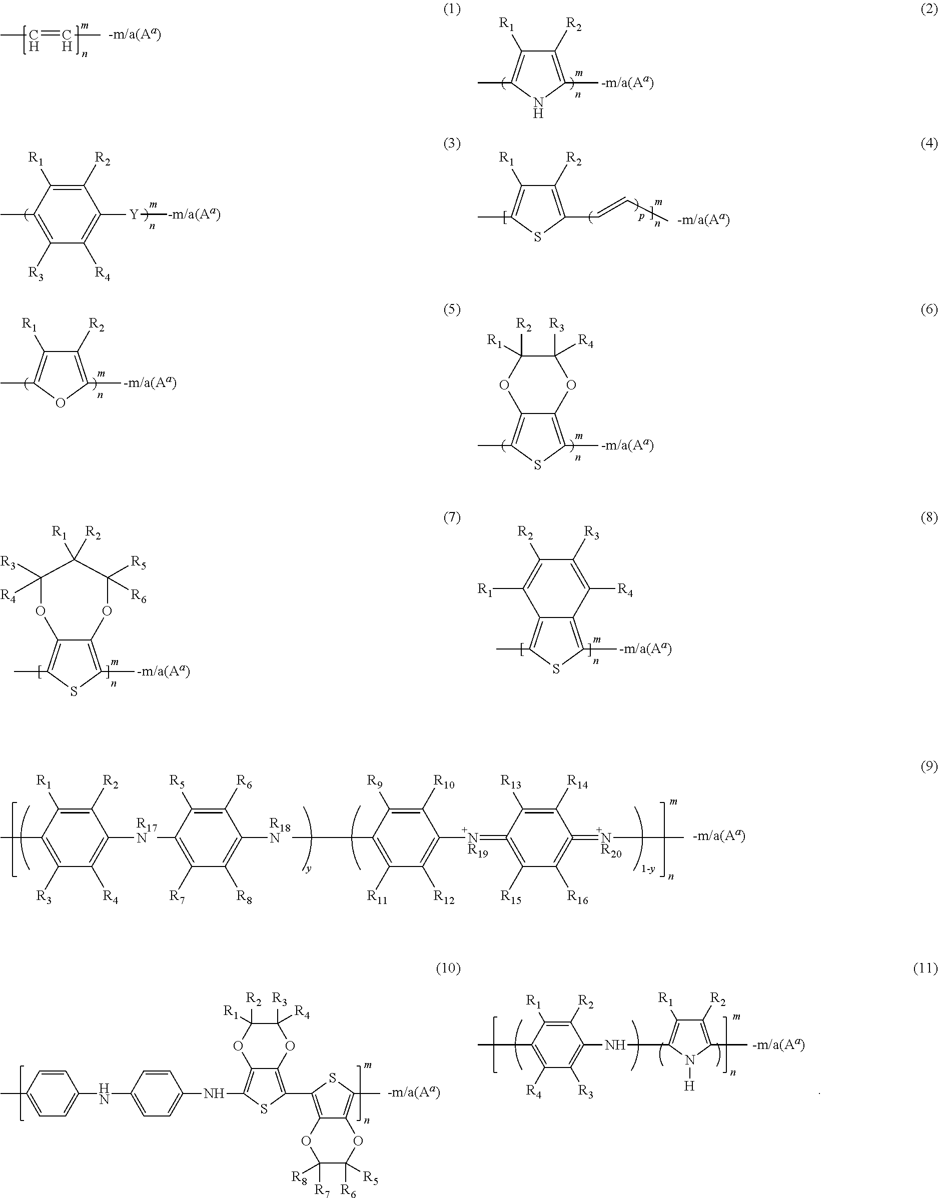

3. The conductive polymer solution of claim 1, wherein the structural formula of the organic solvent is selected from one of the following formulas (12) and (13), and their combinations:

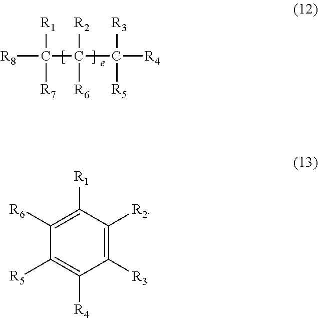

4. The conductive polymer solution of claim 2, wherein n of the formula (1) to the formula (11) is an integer between 3 and 5000, each of R₁ to R₂₀ of the formula (2) to the formula (11) is one selected from H, F, Cl, Br, I, amino, formyl, carboxyl, OCⱼH₂ⱼ₊₁, CⱼH₂ⱼ₊₁, SCⱼH₂ⱼ₊₁, N(CⱼJ₂ⱼ₊₁)₂, CⱼH₂ⱼ₊₁SO₃H, and CⱼH₂ⱼPO₃H₂, j is an integer between 0 and 8, Y of the formula (3) is one selected from S, O, C₆H₄, C═C, C═N, and N═N, p of the formula (4) is an integer between 0 and 3, y of the formula (9) is between 0 and 1, m of the formula (1) to the formula (11) is an integer between −5000 and 5000, a of the formula (1) to the formula (11) is an integer between −5000 and 5000, and A^{a} of the formula (1) to the formula (11) is an organic anion, an organic cation, an inorganic anion, or an inorganic cation.

5. The conductive polymer solution of claim 3, wherein e of the formula (12) is an integer between 0 and 5, and each of R₁ to R₈ of the formulas (12) and (13) is one selected from H, F, Cl, Br, I, amino, formyl, carboxyl, OCⱼH₂ⱼ₊₁, CⱼH₂ⱼ₋₁, SCⱼH₂ⱼ₊₁, N(CⱼH₂ⱼ₊₁)₂, CⱼH₂ⱼ₊₁SO₃H, and CⱼH₂ⱼPO₃H₂, wherein j is an integer between 0 and 8.

6. The conductive polymer solution of claim 1, wherein the doped conjugated polymer is an acid doped conjugated polymer or an oxidant doped conjugated polymer.

7. The conductive polymer solution of claim 1, wherein the organic solvent is selected from a fluorinated organic solvent, mixture solvents containing fluorinated organic solvents, and mixture solvents containing fluorinated and non-fluorinated organic solvents.

8. The conductive polymer solution of claim 1, wherein the organic solvent is selected from hexafluoroisopropanol (HFIP), 1,1,1,3,3,3-hexafluoro-2-phenyl-2-propanol (HFPP), 1,1,1,3,3,3-hexafluoro-2-(p-tolyl)-propanol (HFTP), perfluoropropane (PFP), and their combinations.

9. The conductive polymer solution of claim 1, wherein the concentration of the doped conjugated polymer is less than 40 weight %.

10. The conductive polymer solution of claim 1, wherein the conductive polymer solution is applied to solar cell, capacitor, light-emitting diode (LED), chemical sensor, pattern etching, anti-corrosion, electrostatic discharge (ESD) protection, electrode material, EMI shielding, and electrochromic display.

11. A preparation method of a conductive polymer solution, comprising the following steps of:
mixing a monomer of a conjugated polymer and an oxidant in an acid solution;
conducting a polymerization;
filtering the solution to obtain solid residual;
washing and doping the solid residual to obtain a doped conjugated polymer, wherein the doped conjugated polymer has electrical conductivity and is selected from the group consisting of polyacetylenes, polypyrroles, polyparaphenylenes, polythiophenes, polyfurans, poly(3,4-ethylenedioxythiophenes), poly(3,4-propylenedioxythiophenes), polythianaphthenes, polyanilines, and their copolymers, derivatives and combinations; and
mixing the doped conjugated polymer with an organic solvent, wherein the structural formula of the organic solvent is selected from one of the following formulas (12) and (13), and their combinations: [chemical structure]
